(19) United States
(12) Patent Application Publication
(10) Pub. No.: US 2015/0205882 A1
(43) Pub. Date: Jul. 23, 2015

(54) Testing accessibility and compatibility of websites and web-based software

(71) Applicants: Dean Vukas, San Francisco, CA (US); Joshua Hatwich, San Francisco, CA (US)

(72) Inventors: Dean Vukas, San Francisco, CA (US); Joshua Hatwich, San Francisco, CA (US)

(21) Appl. No.: 12/077,671

(22) Filed: Mar. 19, 2008

Related U.S. Application Data
(60) Provisional application No. 60/895,511, filed on Mar. 19, 2007.
(60) Provisional application No. 60/936,106, filed on Jun. 17, 2007.

(51) Int. Cl. G06F 17/30; G06F 15/177

(52) U.S. Cl. CPC G06F 17/30896; G06F 17/30256

(57) ABSTRACT

The present disclosure includes, among other things, methods, systems, and program products for test accessibility and compatibility of websites and web-based software.

### CROSS-REFERENCE TO RELATED APPLICATIONS

This application is a non-provisional application that claims priority to U.S. Patent Application No. 60/895,511, entitled METHOD, SYSTEM AND PROGRAM PRODUCT FOR TESTING THE ACCESSIBILITY AND BROWSER COMPATIBILITY OF INTERNET WORLD WIDE WEBSITES AND WEB-BASED SOFTWARE, to inventors Vukas, et al., which was filed on Mar. 19, 2007. This application also claims priority to U.S. Patent Application No. 60/936,106, entitled METHOD, SYSTEM AND PROGRAM PRODUCT FOR TESTING THE ACCESSIBILITY AND BROWSER COMPATIBILITY OF INTERNET WORLD WIDE WEBSITES AND WEB-BASED SOFTWARE, to inventors Vukas, et al., which was filed on Jun. 17, 2007.

The disclosures of the above applications are incorporated herein by reference in their entirety.

### BACKGROUND

People access the Internet using a variety of web browsers and computing platforms. People use web browsers on personal computers, mobile phones, smart phones, personal digital assistants, gaming platforms, and devices that allow for browsing the web on a television. While different versions of web browsers and operating systems purport to be compliant with web standards, there remain incompatibilities. Consequently, a given website could render differently (or potentially malfunction) depending on what web browser and computing system are used to view it.

FIG. 1 shows an example of a web page that was rendered differently in two different web browser and operating system configurations. Each web page was rendered by accessing the same Uniform Resource Locator (URL), but web page 100 was rendered by a different operating system and browser than web page 102. Each web page is based on the same underlying markup language document and images; however, web page 100 was rendered differently from web page 102. For example, a background 108 is displayed in web page 100 where there is only blank space 110 in web page 102. Furthermore, an image with text 104 is displayed in web page 100 where there is only blank space 106 in web page 102.

### SUMMARY

In general, one or more aspects of the subject matter described in this specification can be embodied in one or more methods that include receiving one or more requests from a requestor where the requests identify a resource, a first web browser and a first operating system. The resource is rendered to create a first image using the identified first web browser and the first operating system. The requestor is responded to with the first image. Other embodiments of this aspect include corresponding systems, apparatus, and computer program products.

These and other embodiments can optionally include one or more of the following features. A border region is removed in the first image before responding. The first image is modified for a user accessibility test. The resource can be a uniform resource locator. The resource can be a markup language document. The resource is rendered to create a second image using a second web browser and a second operating system, and the requestor is responded to with the second image. The first web browser can be different from the second web browser. The first operating system can be different from the second operating system. One of the first image and the second image is modified for a user accessibility test. The first image and the second image are compared. A result of the comparing is provided to the requestor. The first image and the second image are presented simultaneously on a display device. The images can overlap and the uppermost image can be displayed with variable transparency.

In general, one or more aspects of the subject matter described in this specification can be embodied in one or more methods that include receiving one or more requests from a requestor where the requests identify a resource, a first web browser and a first operating system. The resource is loaded into the identified first web browser running on the first operating system. The first web browser's presentation is mirrored to the requestor. The requestor is allowed to remotely interact with the first web browser. Other embodiments of this aspect include corresponding systems, apparatus, and computer program products.

These and other embodiments can optionally include one or more of the following features. The resource can be a uniform resource locator. The resource can be a markup language document. The resource is loaded into a second web browser running on a second operating system. The second web browser's presentation is mirrored to the requestor. The first web browser can be different from the second web browser. The first operating system can be different from the second operating system. One of the presentations is modified for a user accessibility test. The first web browser's presentation and the second web browser's presentation are presented simultaneously on a display device. The presentations can overlap and the uppermost presentation can be displayed with variable transparency. One or more of the first web browser's presentation and the requestor's interaction with the first web browser are recorded.

Particular embodiments of the invention can be implemented to realize one or more of the following advantages. Web professionals and other web designers can test their websites on different browsers, operating systems, and other configurations and document what their various customers or audience members will experience. Further, designers can produce screenshots of their website or create an interactive (e.g., virtualized) experience for a given configuration. The results of testing can be combined into reports and shared, for example, with clients and colleagues in a variety of formats. Designers can efficiently and accurately assess and report on the accessibility (e.g., to the vision impaired) of websites.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an example of a web page that was rendered differently in two different web browser and operating system configurations.

FIG. 2 shows a flowchart of an example technique for testing websites, web-based software, and the like.

FIGS. 3A-3C show diagrams of an example technique and systems for testing websites, web-based software, and the like.

FIG. 4 shows a flowchart of an example technique for testing websites, web-based software, and the like that allows remote interaction.

FIGS. 5A-5C show diagrams of an example technique and systems for testing website, web-based software, and the like that allows remote interaction.

FIG. 6A shows an example of a web page rendered as it was designed and the same web page modified so that it appears as it would to individuals with certain kinds of colorblindness.

FIG. 6B shows an example of two overlapping images of a web page rendered under different circumstances.

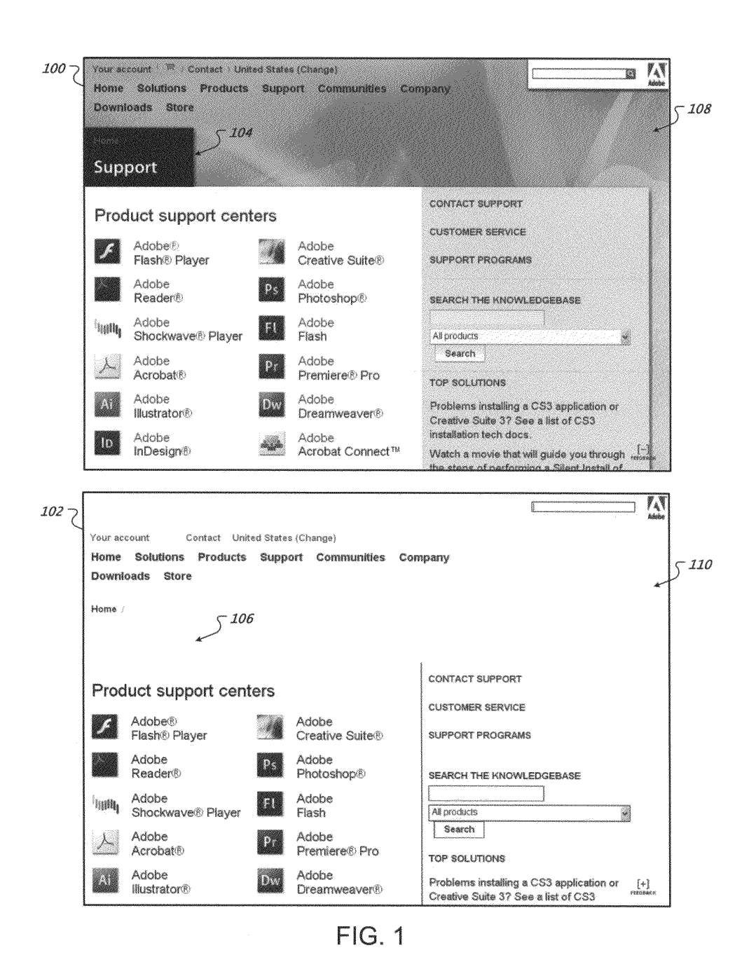

Like reference numbers and designations in the various drawings indicate like elements.

### DETAILED DESCRIPTION

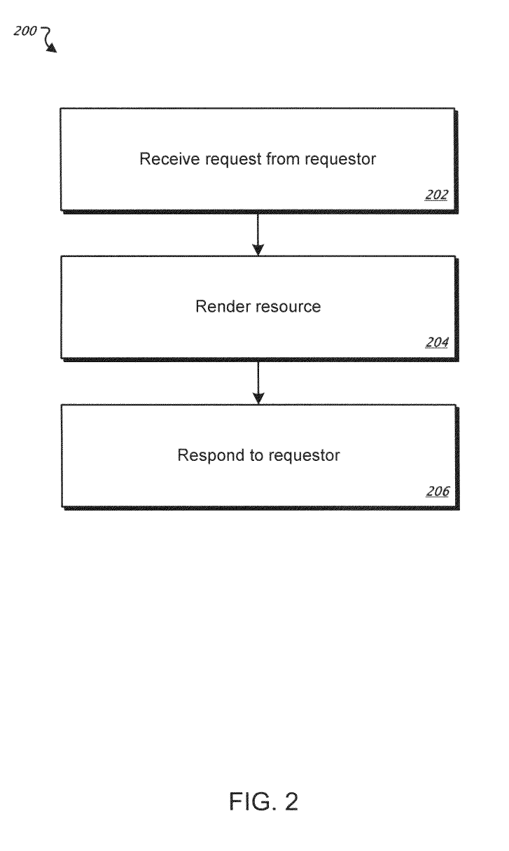

FIG. 2 shows a flowchart of an example technique 200 for testing websites, web-based software, and the like. For purposes of illustration, the technique will be described with respect to a system (e.g., one or more computing systems or servers, or the like) that performs the technique. Examples of testing include, but are not limited to, rendering a web page using a specific web browser and operating system (OS) combination, allowing a user to interact with a web page using a specific web browser and OS combination, comparing renderings of a web page using different combinations of web browsers and OS's, and modifying a rendering of a web page for a user accessibility test.

The system receives a request from a requestor (step 202). The request identifies a resource, a web browser and an OS. For example, the request can specify that web page “http://www.adobe.com” is to be tested on Firefox 2.0.0.12 and Windows XP 2002 Service Pack 2. In some implementations, the resource is a uniform resource locator (URL). In other implementations, the resource is a markup language document itself or other suitable document. The resource optionally includes or references images and other digital items (e.g., applets, audio files, streaming content, programming language statements, and the like). For example, a URL could refer to a web page that has an Adobe Flash presentation (Adobe Flash is available from Adobe Systems Incorporated of San Jose, Calif.), asynchronous JavaScript, and eXtensible Markup Language (XML).

In general, the requestor is a user such as a web designer who sends the request to the system (e.g., by accessing a testing portal with a web browser). Alternatively, the requestor is a process (e.g., an executing software program or script) that can send requests to test various resources. In some implementations, the requestor authenticates by, for example, supplying a username and password into form fields on a testing portal web page. By way of illustration, the system can authenticate the user or process by querying a database (e.g., a Structured Query Language (SQL) database or the like) of user information. The request can be sent over a network if the system is not available locally on the requestor's computing platform.

A web browser is an interactive software program that allows users to browse the web. Web browsers run on a wide variety of computing platforms (e.g., personal computers, mobile phones, and the like). Web browsers can operate in various ways and present various user interfaces and features. Examples of web browsers include Microsoft's Internet Explorer, Apple's Safari, Mozilla's Firefox, and the like. Web browser functionality can be incorporated into other applications which are not, per se, web browsers. As such, the term “web browser” as used throughout this specification refers to any interactive or non-interactive application that has the ability to render web content or a subset of the content.

An OS is a process, library, software object, firmware, or combinations of these, that manages hardware resources, software resources, or both, on a computing platform. Operating systems, like web browsers, run on a wide variety of computing platforms. Examples of OS's include Microsoft's Windows XP and Windows Vista, Apple's OS X, Linux, Symbian OS, Qualcomm's BREW OS, and so on.

The system then renders the resource to create an image using the requested web browser and the operating system (step 204). In implementations where the system comprises more than one server, the system selects which server will render the image. The selection is based on, for example, which servers are operable to run which browsers and operating systems, which servers are busiest, which servers are nearest to the requestor (e.g., using a traceroute tool or the like), which servers are operable to perform a requested user accessibility (UA) test, which servers are available for real time access of an interactive session, and so on. For example, where only a single server is configured to run the web browser and OS, the system can select that server. In contrast, where many servers are configured to run the web browser and OS, the system can select a server that is not busy.

In some implementations, the system renders the resource using a server (e.g., a rendering server) that is different from a server that received the request (e.g., a coordinating server). In other implementations, the coordinating server is also the rendering server and it renders the resource. In further implementations, the coordinating server provides a location of the rendering server to the requestor, who then sends the request to the rendering server.

To render the resource, the rendering server loads the resource into the web browser which is executing on the OS. This can be accomplished in various ways, for example, through a process that uses scripting. To create the image, the rendering system takes a snapshot of the rendered resource as it appears in the web browser. If the request specifies more than one web browser and operating system for testing, the system can render the resource on the additional web browsers and operating systems, and create additional images. In that case, the system selects additional rendering servers in the same or similar manner that it selected the initial rendering server. The additional rendering servers can be the same as the initial rendering server or the same as the coordinating server. Similarly, the system sends the request to the additional rendering servers, either by notifying the requestor of the selected rendering servers or passing the request directly.

The system responds to the requestor with the image (step 206). If the system created any other images (e.g., images of additional testing on additional web browsers and operating systems), the system can respond to the requestor with the additional images. In some implementations, the system displays an advertisement during performance of the technique. For example, after the requestor sends the request, the system can send the advertisement to the requestor's web browser for display while the system is creating the image.

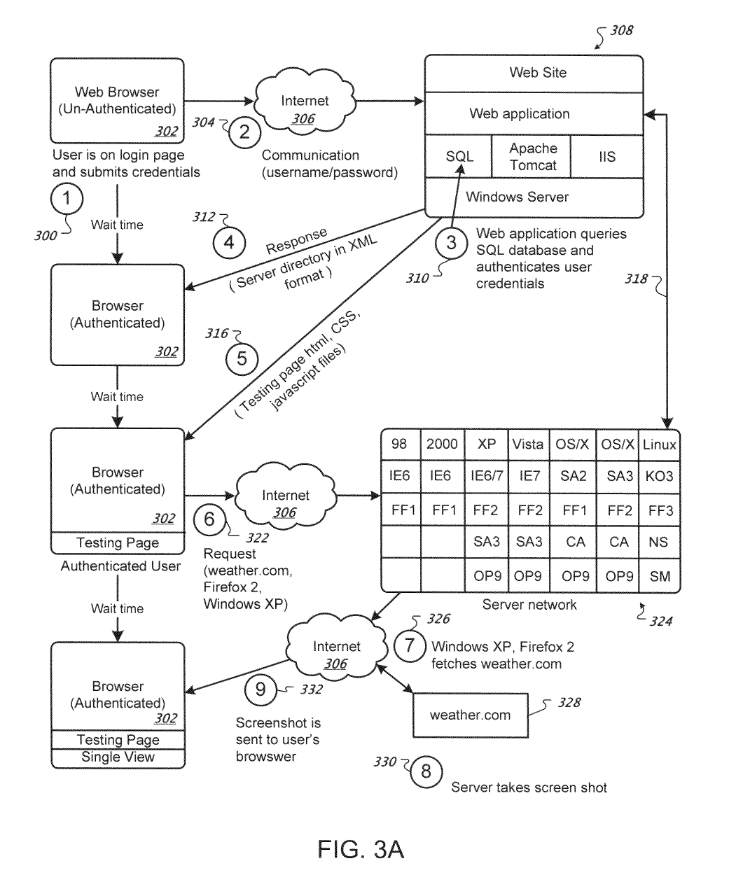

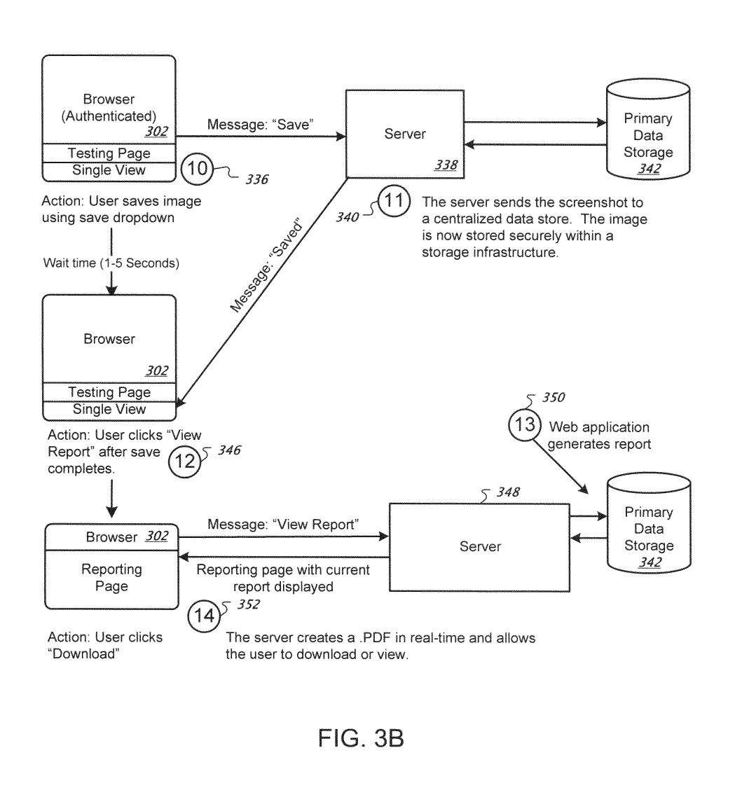

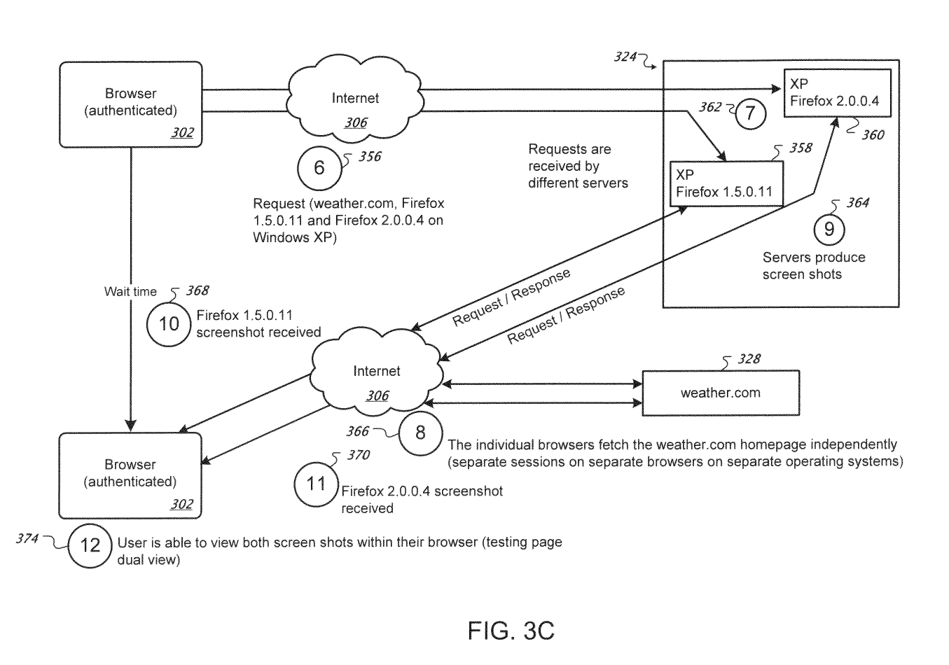

FIGS. 3A-3C show diagrams of an example technique and systems for testing websites, web-based software, and the like. FIG. 3A shows a requestor 302 (e.g., a web or other process) that can initiate a test by sending a request. FIG. 3A also shows a coordinating server (e.g., website server 308) and one or more rendering servers (e.g., server network 324). At step (1) 300, the requestor 302 submits credentials (username and password in this example). At step (2) 304, the credentials are formatted for sending over the Internet 306 using, for example, Extensible Markup Language (XML), JavaScript, a proprietary format, or the like. The credentials (and various other communications) are sent using, for example, HyperText Transfer Protocol (HTTP). Other protocols are possible.

At step (3) 310, the website server 308 receives the credentials. The website server 308 authenticates the requestor 302, in this example, by querying a SQL database. Several applications can support the website server 308, for example, a web application based on the Enterprise Edition of the Java Platform, Apache Tomcat, Microsoft's Internet Information Services, Windows Server, and others.

At step (4) 312, the website server 308 sends the requestor 302 a directory of servers (e.g., in XML format). In some implementations, the directory includes various information about the servers, for example, what browser and OS combinations they support, what languages and resolutions they support, what UA tests they are configured to run, and so on. The directory is stored locally by the requestor 302, for example, as a cookie. The website server 308 communicates (e.g., over a Local Area Network (LAN) 318 or the Internet 306) with servers in the server network 324 to determine which servers to provide to the user.

At step (5) 316, the website server sends the requestor 302 additional information, for example, additional Hypertext Markup Language (HTML) documents, Content Style Sheets (CSS), Javascript files, and the like. The additional information is used, for example, to display an interactive menu of available tests, what tests are most popular (to assist the requestor in selecting a test), account information, and so on.

At step (6) 322, the requestor 302 sends a request over the Internet 306 to one or more rendering servers in the server network 324. In this example, the request specifies the URL “http://www.weather.com”, the web browser Firefox 2, and the operating system Windows XP. Alternatively, this information can be provided in the request at step (2) 304. The requestor 302 selects one or more rendering servers based on the request and the directory of servers (e.g., stored as a cookie in step (4) 312).

In some implementations, the request specifies additional information regarding the testing. For example, the request can specify a language, a screen resolution, a set of user preferences, or the like. In some implementations, the request specifies a UA test (e.g., color blindness filters, impaired vision filters, variable contrast filters, text-only web browser, audio recording from a screen reader). In various implementations, the request specifies preferences for screenshots. For example, the request can specify whether a border region should appear in screenshots (e.g., the browser chrome or frame, including buttons and toolbars), whether screenshots should be compressed, whether the system should wait for a brief period before taking a screenshot (e.g., to give Flash presentations or other web-based software time to load or run), and so on.

Although FIG. 3A depicts the request as being sent from the requestor 320 to a rendering server in the server network 324, various implementations accomplish the same task differently. In alternative implementations, the requestor 302 sends the request to the website server 308, and the website server 308 sends the request (e.g., over a LAN 318 or the Internet 306) to a selected server in the server network 324. In some implementations, the requestor 302 sends the request to the website server 308, and then the website server 308 sends the requestor 302 a location of a rendering server to be used for that particular request.

At step (7) 326, the rendering server uses the requested browser and OS to load the resource specified by the request. In this example, the rendering server uses Windows XP and Firefox 2 to access resource “http://www.weather.com” 328 over the Internet 306 and load the web page into the Firefox 2 browser.

In some implementations, the rendering server is natively running the web browser and OS. In other implementations, the rendering server is virtually running the web browser or the OS. For example, the rendering server can run a virtual machine that runs the web browser and OS. A virtual machine is software that creates a virtualized environment on a computer platform allowing different applications and operating systems to be executed in parallel with the computer or device's core operating system. Examples of virtual machine software include VMware Workstation and Microsoft Virtual PC.

In some implementations, a process or program running on the rendering server simulates mouse and keyboard input to the system. For example, the process can be a Java application that uses a standard Java Application Programming Interface (API) called “Robot.” Other APIs, scripting systems, and the like can be used to accomplish the same effect, for example, the Windows API. In such implementations, the rendering server simulates the experience that a user would have with the website by moving the mouse cursor and keyboard to manipulate the web browser to load the resource (e.g., moving the cursor into a URL input field, pasting the text of a URL, and simulating that the “enter” or “return” key has been pressed).

In other implementations, a process or program running on the rendering server directly manipulates (e.g., controls) the web browser to cause it to load the resource. For example, the process can create a web browser object using Microsoft's Component Object Model (COM) interface, where it can then issue direct instructions to the web browser object to load the resource.

At step (8) 330, the server creates an image of the “http://www.weather.com” web page as displayed by Firefox 2 running on Windows XP. In some implementations, the rendering server waits a specified (e.g., by the requestor) amount of time to take the snapshot. For example, the rendering server can wait 15 seconds to be sure that a Java applet or other web-based software has loaded.

In some implementations, the rendering server uses the Robot API (or the like) to simulate a series of key presses (e.g., “Print Screen” or “Alt+Print Screen”) that causes the operating system to take a screenshot. In other implementations, the system captures the screen directly, for example, by using the Windows API or an equivalent API for the OS. In another example, the system creates the image using Java Advanced Imaging (JAI).

In various implementations, the system processes the image and any other images after it creates them. For example, in some implementations the rendering server compresses the image, for example, as a Joint Photographic Experts Group (JPEG) file. In some implementations, the rendering server creates more than one image over a period of time, or compiles images into a video (e.g., a Moving Picture Experts Group (MPEG) file). Image processing can also include removing a border region (e.g., the browser chrome or frame, including buttons and toolbars), although in some implementations, the image is created without a border region and removal is not necessary.

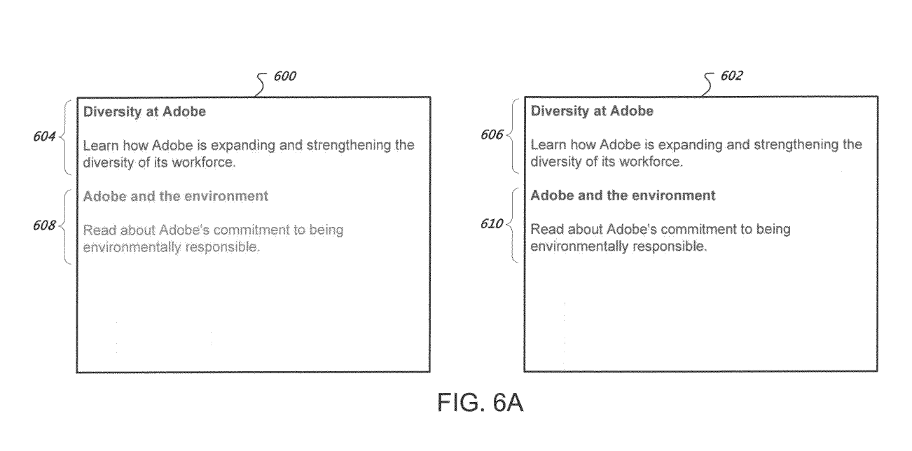

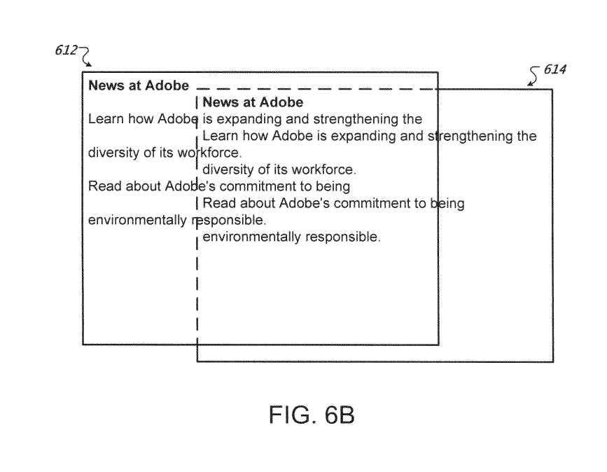

In some implementations, the system modifies the image to perform a UA test. For example, the system can modify the image so that it appears to an ordinary person as it would appear to a person with a vision impairment (e.g., colorblindness). This UA test is discussed below in regards to FIG. 6A. In another example, the system can create an audio file using a screen reader.

In implementations where the system modifies the images, the rendering server can perform the modifications, or the coordinating server can perform the modifications, or the coordinating server can select another server to perform the modifications.

At step (9) 332, the rendering server sends the image to the requestor 302. In some implementations, the rendering server sends multiple images that are displayed simultaneously if the requestor 302 is a web browser, for example. In some implementations, the images overlap and the uppermost image is displayed with variable transparency. In other implementations, the system presents one image of a resource next to another image of the resource where one of the images has been modified for a UA test (e.g., a colorblindness test). Overlapping images are shown in FIG. 6B.

In some implementations, the system compares images. In some implementations, the system provides a result of the comparing to the requestor 302. For example, in some implementations, the system performs similarity testing or visual differencing. The system can compare two images and determine, for example, that they have a certain percentage of pixels that are identical. Furthermore, the system can determine whether the similarity level violates a threshold. In those implementations, the system responds to the requestor 302 with a notification regarding such (e.g., which web browsers and operating systems were used to generate the dissimilar images).

FIG. 3B shows optional additional steps. In some implementations, the system saves the image or any other images in a database. For example, the requestor 302 can request that images generated of a resource using several different browser and OS combinations be saved and associated with an account (e.g., an account that is used for authentication). Where the system generates a report, the system can incorporate saved images into the report. At step (10) 336, the requestor 302 saves the image. In some implementations, the requestor 302 sends a “save” message to a server 338, which in this example is the same server that rendered the image. At step (11) 340, the server 338 sends the screenshot to a data storage server 342 (e.g., using a LAN or the Internet). The server sends a “saved” message to the requestor 302.

In some implementations, the system generates a report. For example, in some implementations, the system compares the image of a web page with an image of the same web page rendered so that it appears as it would to a vision impaired person. Based on the level of similarity, the system can predict whether the web page is compliant with recommendations from international standards bodies such as the World Wide Web Consortium (W3C). In further implementations, the system analyzes a resource by analyzing audio files generated by screen readers on various browser and OS combinations. Based on the audio files, the system can predict whether the resource is compliant with accessibility legislation and create alerts in the report when the probability of compliance is below a threshold. When the system generates a report, it can provide it to the requestor 302.

The report can be an electronic document. An electronic document does not necessarily correspond to a file. A document may be stored in a portion of a file that holds other documents, in a single file dedicated to the document in question, or in multiple coordinated files.

At step (12) 346, the requestor 302 requests to review a report (e.g., by a user clicking “View Report” in a browser) after the save completes. The requestor 302 sends a “View Report” message to a server 348. At step (13) 350, the server 348 generates a report and retrieves an image from the data storage server 342. By way of illustration, if the requestor 302 is a web browser, at step (14) 352 the user of the browser 302 clicks a “Download” button. The server 348 creates a Portable Document Format (PDF) document in real-time and allows the user to download or view the document.

FIG. 3C shows an alternative set of steps where the requestor 302 sends a request that specifies more than one browser and OS combinations. In this example, the resource “http://www.weather.com” is tested on two versions of Firefox (1.5.0.11 and 2.0.0.4) running on Windows XP.

At step (6) 356, the requestor 302 sends two requests that include one resource (“http://www.weather.com”) and two browser and OS combinations. At step (7) 362, two rendering servers 360 and 358 receive the requests. One server 358 handles the request for one browser and OS combination and the other server 360 handles the other request. Alternatively, one rendering server that is configured to run both requested browser and OS combinations (e.g., using virtual machines) receives both requests.

At step (8) 366, the servers 358 and 360 each fetch the “http://www.weather.com” web page. The servers can run the requested browser and OS combinations either natively or on virtual machines. At step (9) 364, the servers produce screen shots using, for example, JAI. At steps (10) 368 and (11) 370, the servers 358 and 360 send the screenshots to the requestor 302. If the requestor 302 is a web browser, at step (12) 374, a user is able to view both screen shots within the browser 302. For example, the browser 302 can show a dual page view so that the pages are side by side or so that one page overlaps the other and is the uppermost page is partially transparent.

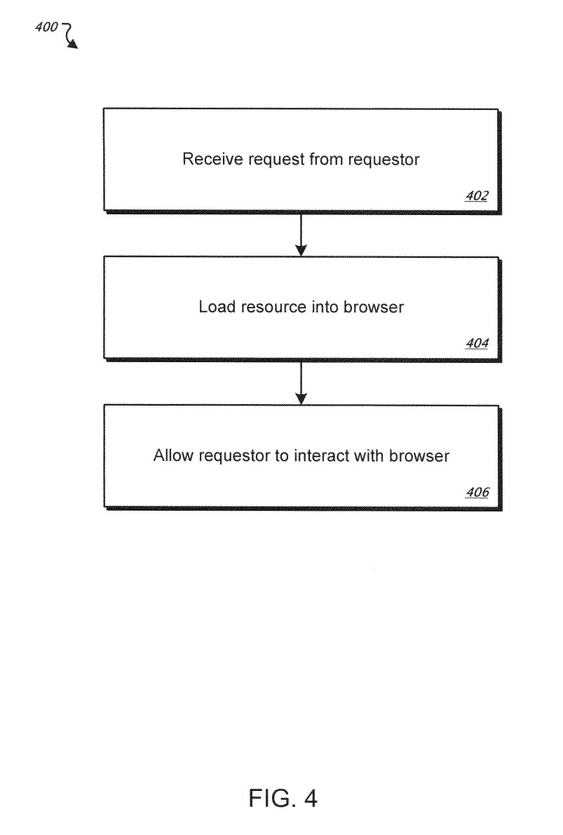

FIG. 4 shows a flowchart of an example technique for testing websites, web-based software, and the like that allows remote interaction. For convenience, the technique will be described with respect to a system (e.g., one or more computing systems or servers, or the like) that performs the technique.

The system receives a request from a requestor (step 402). The request includes a resource for testing on a web browser and an operating system. The system loads the resource into the web browser running on the operating system and mirrors the web browser's presentation to the requestor (step 404). The web browser's presentation can include, for example, on or more of an image, a video stream, an audio stream (e.g., from a screen reader for a user accessibility test), an Adobe Flash presentation, and so on. In some implementations, the rendering server uses remote desktop software (i.e, Remote Browsing, Screen Sharing, Live Mode, Interactive Mode technology, and the like), for example, GoToMyPC, Symantec pcAnywhere, Apple Remote Desktop, custom software based on Virtual Network Computing (VNC), software based on Remote Desktop Protocol (RDP), and so on, to mirror the presentation to the requestor and allow the requestor to remotely interact with the requested web browser (step 406). In some implementations, the rendering server uses remote desktop software (or similar) to allow connections from behind a corporate firewall.

In some implementations, the system further loads the resource into a second web browser running on a second operating system and mirrors the second web browser's presentation to the requestor. The system allows the requestor to remotely interact with the second web browser. The system can present the first web browser's presentation and the second web browser's presentation simultaneously on a display device. In some implementations, the presentations overlap and the uppermost presentation is displayed with variable transparency.

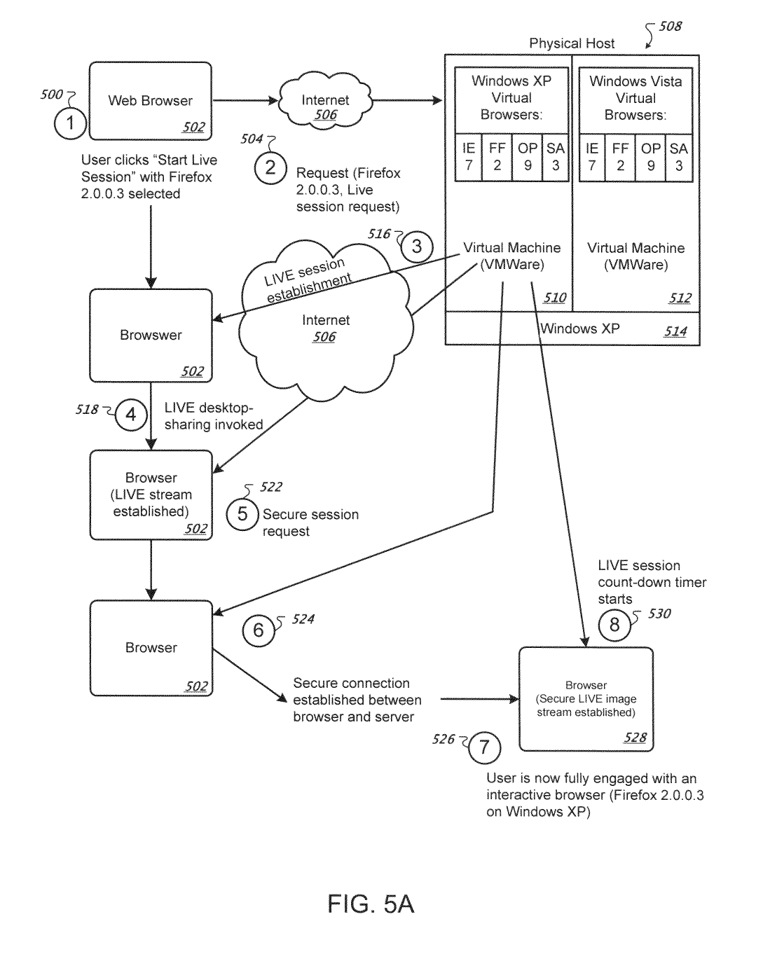

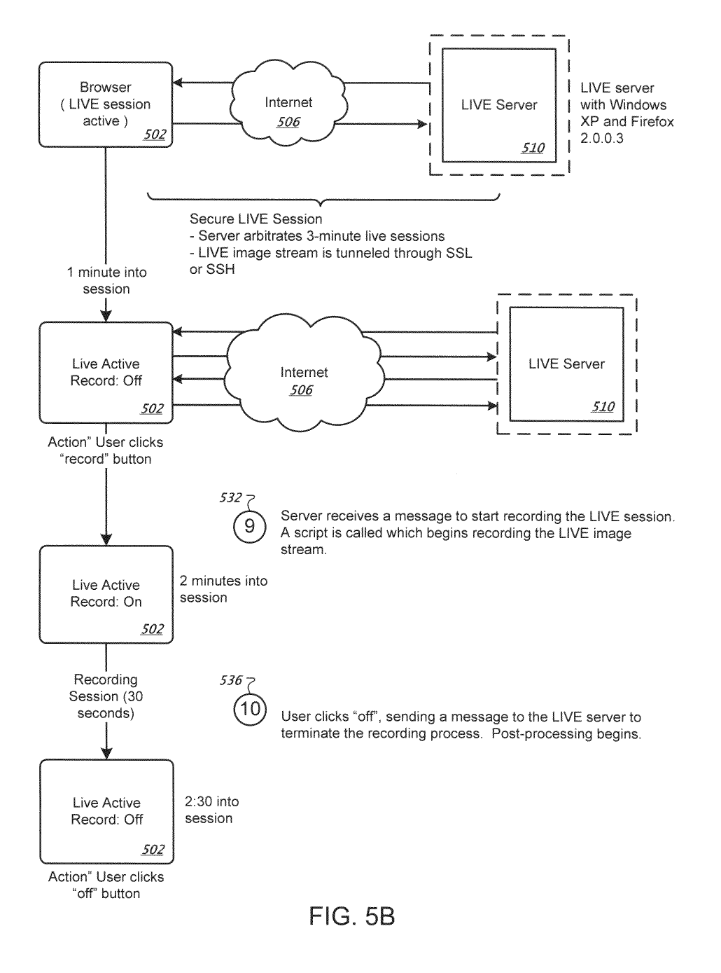

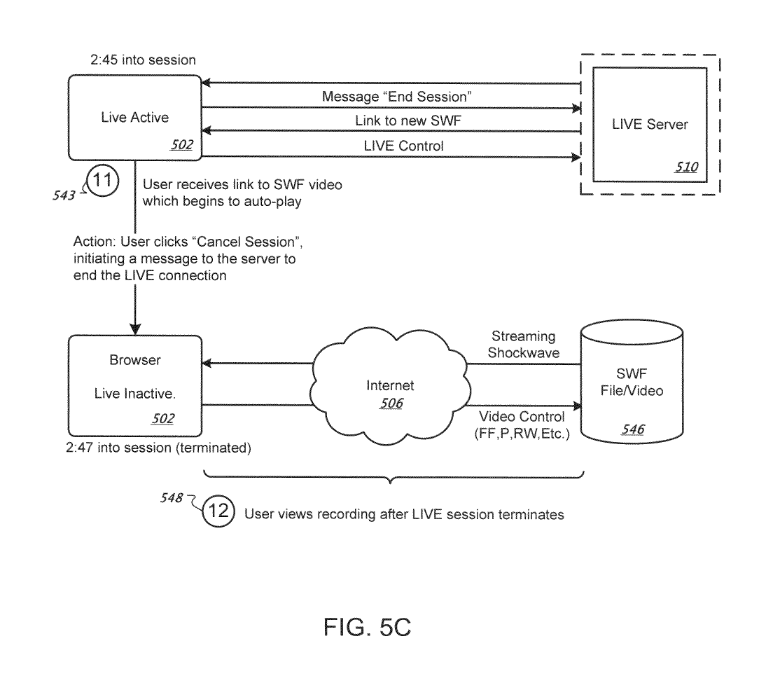

FIGS. 5A-5C are diagrams of an example technique and systems for resource testing such that a requestor can interact with the resource. In FIG. 5A, at step (1) 500, requestor 502 requests a LIVE session (i.e., a session using LIVE technology, which can be proprietary software or other remote desktop software) with a Firefox 2.0.0.3 web browser running on Windows XP. At step (2) 504, the requestor 502 sends the request over the Internet 506 to a physical host 508. In this illustration, the physical host is running the Windows XP OS 514. However, the physical host is also running two virtual machines 510 and 512 (e.g., using VMWare) that are running the Windows XP and Windows Vista OS's. Each virtual machine has one or more virtual web browsers running on it.

At step (3) 516, the physical host begins establishing a LIVE session with the requestor 502. In some implementations, the physical host sends a custom Virtual Network Computing (VNC) Java application (e.g., a VNC client) to the requestor 502. At step (4) 518, the requestor 502 invokes LIVE desktop sharing methods. In some implementations, the requestor 502 loads a custom VNC client. At step (5) 522, the requestor 502 requests a secure session. In some implementations, the requestor 502 requests a secure VNC password and user name, and the physical host 508 responds with the password and user name. At step (6) 524, the requestor 502 authenticates with a LIVE server on a virtual machine 510, thus establishing a LIVE session. In some implementations, the LIVE server is a VNC server. In various implementations, the secure session is established using Secure Sockets Layer (SSL) or the Secure Shell protocol (SSH). Through the LIVE session, the requestor 502 can remotely provide keyboard and mouse input to the web browser on the physical host 508, and receive rendered images from the web browser reflecting the current rendering of the resource as modified by the input.

In some implementations, the system requires the requestor 502 to periodically authenticate with the rendering server (e.g., the VNC process on the rendering server, or the like). For example, in some implementations, a coordinating server that has authenticated the requestor 502 provides a password to the requestor 502 every three minutes. Alternatively, the system does not require the requestor 502 to authenticate or only requires authentication once. For example, where the secure session is established using SSL/SSH, periodic authentication is handled automatically at the transport layer.

At step (7) 526, the requestor 502 interacts with a Firefox 2.0.0.3 browser running on Windows XP (e.g., on virtual machine 510). In various implementations, the system limits the amount of time that the requestor 502 can remotely interact with the web browser. For example, the system can allow the requestor 502 to remotely interact with the web browser for three minutes, and then prompt the requestor 502 for payment for additional time, or present an advertisement. Alternatively, the system can bill the requestor 502 for the amount of time of the interaction. At step (8) 530, a LIVE session count-down timer starts.

FIG. 5B shows additional optional steps. FIG. 5B shows a web browser 502 interacting with a LIVE server (e.g., virtual machine 510, or physical host 508). In some implementations, the server records one or more of the web browser's presentation and the requestor's 502 interaction with the web browser. For example, in some implementations, the server uses a script (e.g., a Python script) to record a LIVE image stream (e.g., a VNC image stream). The recording can be accomplished in various ways. For example, the script can connect on the same User Data Protocol (UDP) port that the requestor 502 is using to interact with the LIVE server (e.g., a VNC process) in an observe-only mode. The recording can be formatted in various file formats, for example, MPEG, Adobe Shockwave (.SWF), and so on.

At step (9) 532, the user clicks a “record” button one minute into the LIVE session. The requestor 502 sends a “record” message to the server. The server calls a script or begins another process that begins recording the LIVE image stream. The server captures the recording in SWF format. The requestor 502 indicates that recording is turned on. At step (10) 536, the user clicks an “off” button. The requestor 502 sends a message to the server to terminate the recording process. The requestor 502 indicates that recording is turned off.

In some implementations, the system can post-process the recording. In some implementations, the system applies the same post-processing to a recording that it can apply to one or more single images. For example, the system can generate reports for the web page as viewed during the interaction, apply UA tests, save the recording in a data storage server, and so on.

FIG. 5C shows additional optional steps. At step (11) 542, the requestor 502 receives a link to the recorded video, which in some implementations, begins to auto-play. The user clicks a “cancel session” button, and the requestor 502 sends a “End Session” message to the server. The server terminates the LIVE connection. At step (12) 548, the user views the recording after the live session has terminated. The user can control the video, e.g., cause it to fast-forward, pause, rewind, and so on. The SWF video is stored on a data storage server 546.

FIG. 6A shows an example of a web page rendered as it was designed 600 and the same web page modified 602 so that it appears as it would to individuals with certain kinds of colorblindness. Thus, the web page can be evaluated to determine if it will still appear satisfactory to a colorblind person.

The web page rendered as designed 600 shows two paragraphs of text 604 and 608, one paragraph that is green 604 and one paragraph that is red 608. Various web pages use different colors for text and images to draw the reader's attention or emphasize certain elements.

The web page as modified 600 shows the same two paragraphs of text 606 and 610; however, both paragraphs 606 and 610 appear green. This is how some colorblind individuals would see the web page. To those individuals, red colors appear to be green.

In some implementations, the modified web page 602 is generated by examining each pixel in an image and, if a colorblind person would view the color of that pixel differently, replacing that pixel with the color that the colorblind person would see. Various techniques can be used to accomplish the modification. Furthermore, similar modifications permit similar UA tests (e.g. impaired vision filters, variable contrast filters, text-only web browser, and so on).

FIG. 6B shows an example of two overlapping images 612 and 614 of a web page rendered under different circumstances. The uppermost image 614 is partially translucent. The uppermost image can be displayed with variable transparency. By placing the two images in this manner, differences between the two images of the web page can be more easily discerned.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

A “request” as used in this specification can refer to a single message or multiple messages.

While this specification contains many implementation details, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. For example, the actions recited in the claims can be performed in a different order and still achieve desirable results.

1. A computer-implemented method, the method comprising:
receiving one or more requests from a user or a process that sends requests where the one or more requests identify a resource, a first web browser, and a first operating system
rendering the resource on a server to create a first image using the identified first web browser and the first operating system;
rendering the resource to create a second image using a second web browser and a second operating system;
comparing the created first image and the created second image to generate a comparison; and
responding to the user or the process that sends requests based on the comparison;
wherein comparing the created first and second images comprises determining a percentage of identical pixels between the created first and second images, and wherein a result of the comparison includes the percentage.

2. The method of claim 1, further comprising:
removing a border region in the created first image before responding; or
modifying the created first image for a user accessibility test.

3. The method of claim 1, where the resource is a uniform resource locator.

4. The method of claim 1, where the resource is a markup language document.

5. (canceled)

6. The method of claim 1, where the first web browser is different from the second web browser or the first operating system is different from the second operating system.

7. The method of claim 1, where one of the created first image and the created second image is modified for a user accessibility test.

8. (canceled)

9. (canceled)

10. The method of claim 1, further comprising:
presenting the created first image and the created second image simultaneously on a display device.

11. The method of claim 10 where the images overlap and where the uppermost image is displayed with variable transparency.

12. A computer-implemented method, comprising:
receiving, at a server, one or more requests from. a requestor where the requests identify a resource, a first web browser, and a first operating system;
loading the resource to create a first image using the identified first web browser running on the first operating system on the server and mirroring the first web browser's presentation to the requestor; and
allowing the requestor to remotely interact, via a network connection between the server and the requestor, with the first web browser;
loading the resource to create a second image using a second web browser and a second operating system on the server and mirroring the second web browser's presentation to the requestor;
allowing the requestor to remotely interact, via the network connection, with the second web browser;
comparing the created first image and the created second image to generate a comparison, and
responding to the requestor based on the comparison.

13. The method of claim 12, where the resource is at least one of a uniform resource locator and a markup language document.

14. (canceled)

15. (canceled)

16. The method of claim 12, where the first web browser is different from the second web browser or the first operating system is different from the second operating system.

17. The method of claim 12, where one of the presentations is modified for a user accessibility test.

18. The method of claim 12, further comprising:
presenting the first web browser's presentation and the second web browser's presentation simultaneously on a display device.

19. The method of claim 18, where the presentations overlap and where the uppermost presentation is displayed with variable transparency.

20. (canceled)

21. A non-transitory computer program product, encoded on a computer-readable storage device medium, operable to cause data processing apparatus to perform operations comprising:
receiving one or more requests from a user or a process that sends requests where the one or more requests identify a resource, a first web browser, and a first operating system;
rendering the resource on a server to create a first image using the identified first web browser and the first operating system;
rendering the resource to create a second image using a second web browser and a second operating system;
comparing the created first image and the created second image to generate a comparison; and responding to the user or the process that sends requests based on the comparison;
wherein comparing the created first and second images comprises determining a percentage of identical pixels between the created first and second images, and wherein a result of the comparison includes the percentage.

22. The computer program product of claim 21, where the operations further comprise:
removing a border region in the created first image before responding; or
modifying the created first image for a user accessibility test.

23. The computer program product of claim 21, where the resource is a uniform resource locator.

24. The computer program product of claim 21, where the resource is a markup language document.

25. (canceled)

26. The computer program product of claim 21, where the first web browser is different from. the second web browser or the first operating system is different from the second operating system.

27. The computer program product of claim 21, where one of the created first image and the second image is modified for a user accessibility test.

28. (canceled)

29. (Cancelled)

30. The computer program. product of claim 21, where the operations further comprise:
presenting the first image and the second image simultaneously on a display device.

31. The computer program product of claim 30, where the images overlap and where the uppermost image is displayed with variable transparency.

32. A non-transitory computer program product, encoded on a computer-readable storage device medium, operable to cause data processing apparatus to perform operations comprising:
receiving one or more requests from a requestor where the requests identify a resource, a first web browser, and a first operating system;
loading the resource into the identified first web browser running on the first operating system and mirroring the first web browser's presentation to the requestor; and
allowing the requestor to remotely interact, via a network connection between the data processing apparatus and the requestor, with the first web browser;
loading the resource to create a second image using a second web browser and a second operating system and mirroring the second web browser's presentation to the requestor;
allowing the requestor to remotely interact, via the network connection, with the second web browser;
comparing the created first image and the second image to generate a comparison, and
responding to the requestor based on the comparison.

33. The computer program product of claim 32, where the resource is at least one of a uniform resource locator and a markup language document.

34. (canceled)

35. (canceled)

36. The computer program. product of claim 32, where the first web browser is different from the second web browser or the first operating system is different from the second operating system.

37. The computer program product of claim 32, where one of the presentations is modified for a user accessibility test.

38. The computer program product of claim 32, where the operations further comprise:
presenting the first web browser's presentation and the second web browser's presentation simultaneously on a display device.

39. The computer program product of claim 38, where the presentations overlap and where the uppermost presentation is displayed with variable transparency.

40. (canceled)

41. A system comprising one or more servers, wherein each server has a processor coupled to a memory, operable to perform operations comprising:
receiving one or more requests from a user or a process that sends requests where the one or more requests identify a resource, a first web browser, and a first operating system;
rendering the resource on a server to create a first image using the identified first web browser and the first operating system;
rendering the resource to create a second image using a second web browser and a second operating system;
comparing the created first image and the second image to generate a comparison; and
responding to the user or the process that sends requests based on the comparison;
wherein comparing the created first and second images comprises determining a percentage of identical pixels between the created first and second images, and wherein a result of the comparison includes the percentage.

42. The system of claim 41, where the operations further comprise:
removing a border region in the created first image before responding; or
modifying the created first image for a user accessibility test.

43. The system of claim 41, where the resource is a uniform resource locator.

44. The system of claim 41, where the resource is a markup language document.

45. (canceled)

46. The system of claim 41, where the first web browser is different from the second web browser or the first operating system is different from the second operating system.

47. The system of claim 41, where one of the created first image and the created second image is modified for a user accessibility test.

48. (canceled)

49. (canceled)

50. The system of claim 41, where the operations further comprise:
presenting the created first image and the created second image simultaneously on a display device.

51. The system of claim 50, the images overlap and where the uppermost image is displayed with variable transparency.

52. A system comprising one or more servers, wherein each server has a processor coupled to a memory, operable to perform operations comprising:
receiving one or more requests from a requestor where the requests identify a resource, a first web browser, and a first operating system;
loading the resource into the identified first web browser running on the first operating system and mirroring the first web browser's presentation to the requestor; and
allowing the requestor to remotely interact, via a network connection between the one or more servers and the requestor, with the first web browser;
loading the resource to create a second image using a second web browser and a second operating system and mirroring the second web browser's presentation to the requestor;
allowing the requestor to remotely interact, via the network connection, with the second web browser;
comparing the created first image and the created second image to generate a comparison, and
responding to the requestor based on the comparison.

53. The system of claim 52, where the resource is at least one of a uniform resource locator and a markup language document.

54. (canceled)

55. (canceled)

56. The system of claim 52, where the first web browser is different from the second web browser or the first operating system is different from the second operating system.

57. The system of claim 52, where one of the presentations is modified for a user accessibility test.

58. The system. of claim 52, where the operations further comprise:
presenting the first web browser's presentation and the second web browser's presentation simultaneously on a display device.

59. The system of claim 58, where the presentations overlap and where the uppermost presentation is displayed with variable transparency.

60. (canceled)

61. The method of claim 1, where comparing the created first and second images comprises at least one of a similarity testing and a visual differencing.

62. (canceled)

63. The method of claim 1, wherein comparing the created first and second images further comprises identifying a similarity of the images based on the percentage relative to a threshold and wherein the comparison include the similarity.

64. The method of claim 12, where comparing the created first and second images comprises at least one of a similarity testing and a visual differencing.

65. The method of claim 12, wherein comparing the created first and second images comprises determining a percentage of identical pixels between the first and second images, and wherein a result of the comparison includes the percentage.

66. The method of claim 65, wherein comparing the created first and second images further comprises identifying a similarity of the images based on the percentage relative to a threshold and wherein the comparison include the similarity.

67. The computer program product of claim 21, where comparing the created first and second images comprises at least one of a similarity testing and a visual differencing.

68. (canceled)

69. The computer program product of claim 21, wherein comparing the created first and second images further comprises identifying a similarity of the images based on the percentage relative to a threshold and wherein the comparison include the similarity.

70. The computer program. product of claim 32, where comparing the created first and second images comprises at least one of a similarity testing and a visual differencing.

71. The computer program product of claim 32, wherein comparing the created first and second images comprises determining a percentage of identical pixels between the created first and second images, and wherein a result of the comparison includes the percentage.

72. The computer program product of claim 71, wherein comparing the created first and second images further comprises identifying a similarity of the images based on the percentage relative to a threshold and wherein the comparison include the similarity.

73. The system of claim 41, where comparing the created first and second images comprises at least one of a similarity testing and a visual differencing.

74. (canceled)

75. The system of claim 41, wherein comparing the created first and second images further comprises identifying a similarity of the images based on the percentage relative to a threshold and wherein the comparison include the similarity.

76. The system of claim. 52, where comparing the created first and second images comprises at least one of a similarity testing and a visual differencing.

77. The system. of claim 52, wherein comparing the created first and second images comprises determining a percentage of identical pixels between the first and second images, and wherein the comparison includes the percentage.

78. The system of claim 77, wherein comparing the created first and second images further comprises identifying a similarity of the images based on the percentage relative to a threshold and wherein a result of the comparison include the similarity.
